(19) United States
(12) Patent Application Publication
(10) Pub. No.: US 2015/0242930 A1
(43) Pub. Date: Aug. 27, 2015

(54) Purchasing Feedback System

(71) Applicants: Alexander Greystoke, Lakeway, TX (US); Shy Blick, Austin, TX (US)

(72) Inventors: Alexander Greystoke, Lakeway, TX (US); Shy Blick, Austin, TX (US)

(21) Appl. No.: 14/640,865

(22) Filed: Mar. 6, 2015

Related U.S. Application Data
(63) Continuation-in-part of application No. 14/327,543, filed on Jul. 9, 2014.
Application No. 14/327,543 is a continuation-in-part of application No. 14/169,058, filed on Jan. 30, 2014.
Application No. 14/169,058 is a continuation-in-part of application No. 14/169,060, filed on Jan. 30, 2014.
(60) Provisional application No. 61/759,314, filed on Jan. 31, 2013.
(60) Provisional application No. 61/759,317, filed on Jan. 31, 2013.
(60) Provisional application No. 61/844,355, filed on Jul. 9, 2013.
(60) Provisional application No. 61/844,353, filed on Jul. 9, 2013.
(60) Provisional application No. 61/844,350, filed on Jul. 9, 2013.

(51) Int. Cl. G06Q 30/06; G06N 99/00; G06N 5/04

(52) U.S. Cl. CPC G06Q 30/0631; G06N 5/04; G06N 99/005

(57) ABSTRACT

In some embodiments, systems and methods may include receiving feedback corresponding to one or more purchase options from a device. The feedback may include an indication of a purchase option or options perceived to be better by a particular consumer and an explanation of why the option or options is better. The systems and methods may include verifying the feedback, communicating the feedback to one or more suppliers or to the seller's yield management system to obtain competing offers, and communicating data to the device. In some embodiments, the data may include comments related to the “better” option, other information, competing offers, or any combination thereof.

### CROSS-REFERENCE TO RELATED APPLICATION(S)

The present application is a continuation-in-part of and claims priority to U.S. patent application Ser. No. 14/327,543, filed on Jul. 9, 2014, and entitled “Computer-Aided Decision Systems,” which is a continuation-in-part of and claims priority to U.S. patent application Ser. No. 14/169,058, filed on Jan. 30, 2014, entitled “VIRTUAL PURCHASING ASSISTANT”, which claimed priority to U.S. Provisional Patent Application No. 61/759,314, filed on Jan. 31, 2013, and entitled “VIRTUAL PURCHASING ASSISTANT”; and is also a continuation-in-part of and claims priority to U.S. patent application Ser. No. 14/169,060 filed on Jan. 30, 2014, entitled “DUAL PUSH SALES OF TIME SENSITIVE INVENTORY”, which claimed priority to U.S. Provisional Patent Application No. 61/759,317, filed on Jan. 31, 2013, and entitled “DUAL PUSH SALES OF TIME SENSITIVE INVENTORY”; and is also a non-provisional of and claims priority to U.S. Provisional Patent Application No. 61/844,355, filed on Jul. 9, 2013, entitled “INVENTORY SEARCHING WITH AN INTELLIGENT RECOMMENDATION ENGINE”; is also a non-provisional of and claims priority to U.S. Provisional Patent Application No. 61/844,353, filed on Jul. 9, 2013, entitled “SINGLE PAGE TRAVEL SEARCH AND RESULTS MODIFICATION”; and is also a non-provisional of and claims priority to U.S. Provisional Patent Application No. 61/844,350, filed on Jul. 9, 2013, entitled “SEARCHING FOR INVENTORY USING AN ARTIFICAL INTELLIGENCE PRIORITIZATION ENGINE”; the contents of all of which are hereby incorporated by reference in their entireties.

### FIELD

The present disclosure is related to artificial intelligence based decision systems, which can be implemented by a computing device, such as a desktop, laptop, tablet computer, smart phone, or any other data processing device or combinations thereof. More particularly, the present disclosure is related to computer-aided purchasing systems configured to receive purchase option feedback.

### BACKGROUND

Computers are complex machines that allow individuals to receive the benefit of significant computational processing power. However, even with sophisticated software, computers merely perform the functions they are specifically programmed to do and generally do not account for differences in users when performing such functions. The computer is generally ignorant of the user's needs. For example, when a user performs a search for information via a computer, the quality of search and thus the quality of the search result will be confined explicitly to what the search system is programmed to return and to the terms provided by the user.

While past computers merely provide pre-programmed results, much work has been done in the area of artificial intelligence (“AI”), which can be defined as any attempt to allow human thinking characteristics (or the artificial representation of such human thinking characteristics). Generally, intelligence is the ability to adapt one's behavior to fit new circumstances. Thus, the goals of AI are to do things with a computer that require intelligence when done by humans. However, some of the difficulties in building an intelligent machine include deduction and learning. Deduction systems have been designed but they can require enormous computational resources once the problem goes beyond a certain size. Rote learning is relatively easy to implement on a computer; however, learning that allows the learner to perform better in situations not previously encountered is much more difficult.

SUMMARY

The systems and processes described herein can provide continuous, intelligent, personally targeted, real-time decision-making tailored specifically to user preferences, behaviors, and locations and in multiple dimensions (reactively and proactively and across various sources of information or products). Such systems can transform the entire decision-making experience by allowing users to initiate a decision process, then lean back, relax, and get on with their lives. In certain embodiments, users can identify what they are looking for or want, and then the systems and processes described herein can select and present the best results for the particular user and based on real-time prioritization. Further, the systems and processes described herein may actively continue to analyze and provide even better options for each user from which he/she may make decisions.

In some embodiments, a data storage device comprising instructions that, when executed by a processor, cause the processor to receive feedback corresponding to a plurality of purchase options from a device via a network and to selectively communicate data related to the feedback to at least one of a supplier and a yield management system. The instructions may further cause the processor to receive data from at least one of the supplier and the yield management system based on the feedback and provide a graphical user interface including the received data to the device via the network. The received data can include at least one of a competing purchase option, information related to the feedback, and recommendations.

In some embodiments, a method may include providing purchase options to a device and receiving feedback from the device including data related to at least one of the purchase options. The method may further include determining a reliability associated with the feedback and communicating data related to the feedback and the reliability to a yield management system and to at least one supplier. The method may also include receiving data from the yield management system and the at least one supplier in response to the data related to the feedback and selectively providing at least a portion of the received data to the device. The received data may include at least one of a competing purchase option to compete with a preferred option communicated in the feedback, advice related to the one of the purchase options and the preferred option, and an explanation about why no competing purchase option is provided.

The system may receive feedback with regard to the provided purchase options from a device, such as a computing device, and this feedback can be used to determine further purchase options, which may be more desirable to a user. The feedback may include a “better” purchase option than those provided by the system. In some embodiments, a “better” purchase option may be one that is more appealing to a particular consumer as compared to options presented by the system for any number of reasons (for example better price, better timing, preferred airline, preferred change policies, other parameters, or any combination thereof). In response to the feedback, the systems and methods may include asking the device to verify the better purchase option with details about the “better” purchase option and where it can be found and optionally automatically verifying whether the “better” purchase option actually exists. If the “better” offer is legitimate, the systems and methods may include communicating data about the “better” purchase option to the one or more suppliers, possibly receiving one or more competing purchase options from the suppliers, and selectively providing at least one of the competing purchase options to a device in response to the “better” purchase option.

In some embodiments, the “better” purchase option may be provided to the computing system or to a yield management system of the computing system, which may process the “better” purchase option to determine parameters of the option. After determining the parameters, the computing system may determine one or more other offers that correspond to the parameters of the “better” purchase option and may provide the other offers to a device.

As applied to retail suppliers, the systems and processes described herein can reduce the cost and time involved in locating customers. In some embodiments, the systems and methods described herein can help a supplier to avoid losing a customer to another supplier, such as by notifying the supplier of the customer's needs and why the customer feels the supplier isn't meeting them either in isolation, or compared to a third party that the customer feels is meeting them and allowing the supplier to compete for or to retain the customer's business. The systems may also enhance customer loyalty by facilitating communications between the customer and the supplier. Suppliers may also be able to use the systems and methods to sell inventory, up-sells, and cross-sells, using dynamic pricing and segmentation, while minimizing public price degradation or cannibalization.

Some examples provided herein reference the travel industry sector, which is a good example of how the systems herein can provide valuable decision-making capabilities; however, the travel sector is only one of many different sectors in which the systems and processes herein can be implemented. Many other examples, details, variations, and implementations are provided herein.

In still other embodiments, a memory device may include instructions that, when executed, cause a process to receive feedback from a device in response to providing a set of purchase options and determine a reliability of the feedback. The instructions may further cause the processor to communicate the feedback and the reliability to at least one of a yield management system and a supplier and to receive data related to the feedback from at least one of the yield management system and the supplier. The instructions may further cause the processor to provice at least a portion of the received data to the device.

### BRIEF DESCRIPTION OF THE DRAWINGS

FIG. 1 is a block diagram of a system including a purchasing feedback system, in accordance with certain embodiments of the disclosure.

FIG. 2 is a block diagram of a system including a purchasing feedback system, in accordance with certain embodiments of the disclosure.

FIG. 3 is a schematic view of an example implementation of a persona-based decision system, implemented to allow searching for inventory, such as travel arrangements and tickets, in accordance with certain embodiments of the disclosure.

FIG. 4A is an example view of a user interface including travel purchase options and user-selectable feedback elements, in accordance with certain embodiments of the disclosure.

FIG. 4B is an example view of the user interface of FIG. 4A and including a popup menu allowing adjustments to bases for the suggested results, in accordance with certain embodiments of the disclosure.

FIG. 4C is an example view of the user interface of FIGS. 4A and 4B and including a popup window to receive information about a “better” option, in accordance with certain embodiments of the disclosure.

FIG. 5 is a flowchart of a method of responding to purchasing feedback, in accordance with certain embodiments of the present disclosure.

FIG. 6 is a flowchart of a method of receiving and responding to purchasing feedback, in accordance with certain embodiments of the present disclosure.

FIG. 7 is a flowchart of a method of receiving purchasing feedback and learning based on the purchasing feedback, in accordance with certain embodiments of the present disclosure.

In the following discussion, the same reference numbers are used in the various embodiments to indicate the same or similar elements.

### DETAILED DESCRIPTION

In the following detailed description of the embodiments, reference is made to the accompanying drawings which form a part hereof, and in which embodiments are shown by way of illustrations. It is to be understood that features of the various described embodiments may be combined, other embodiments may be utilized, and structural changes may be made without departing from the scope of the present disclosure.

One or more aspects or features of the subject matter described herein can be realized in digital electronic circuitry, integrated circuitry, specially designed application specific integrated circuits (ASICs), field programmable gate arrays (FPGAs) computer hardware, firmware, software, or combinations thereof. In accordance with various embodiments, the methods and functions described herein may be implemented as one or more software programs running on a computer processor of a computing device, such as a server, desktop computer, or mobile device, such as a laptop computer or smart phone. Dedicated hardware implementations including, but not limited to, application specific integrated circuits, programmable logic arrays, and other hardware devices can likewise be constructed to implement the methods and functions described herein. Further, the methods and functions described herein may be implemented as a device, such as a non-volatile computer readable storage medium or memory device, including instructions that, when executed, cause a processor to perform the methods.

Embodiments of systems, methods and devices are described below that may allow a user to provide feedback with respect to purchase options. Further, in some embodiments, the systems, methods and devices may provide a notification of missing options (i.e., something that the system or device detects elsewhere that it would expect to see in in the context of this search). In some examples, the feedback may include a “better” option or options. In some embodiments, the systems, methods and devices may be configured to verify the “better” option or options to make sure each of them are legitimate including by asking for additional detail from the device or requiring it at the outset, to determine other options to compete with the “better” option or options, and to provide the other options to the device. In some embodiments, the systems, methods and devices may refine its searches and its weighing and filtering processes based on the feedback. In some embodiments, search results may be weighed, filtered and arranged based on a digital persona associated with a particular consumer, prior to transmission of the weighed and filtered search results to a device associated with the consumer, and the systems, methods and devices may be configured to refine the digital persona in response to the feedback.

As used herein, a digital persona is a digital representation of an entity (a human, corporation, group, etc.). A digital persona is a digital representation of a virtual being or a real being that has a set of preferences or that applies certain rules in relation to a certain problem. An entity is a depiction of a virtual or real being that has a set of preferences, weights or tendencies in relation to a certain problem at a point in time. A digital persona can evolve over time based on a variety of factors.

In some embodiments, a potential solution is a solution to a problem that may or may not relate to the priorities of a corresponding digital persona. In certain embodiments, a potential solution may represent a potential option that may be selected to satisfy one or more of the digital persona's needs or solve their problem. A chosen or selected solution is at least one of the potential solutions that, by way of weighing, was chosen to be appropriate (or most appropriate) to solve the problem or that was determined, based on scoring, to be the most satisfactory to the digital persona.

In some embodiments, an engine can be a software mechanism that can process several tasks. For example, an engine may read digital persona preferences; obtain a list of potential solutions; combine competing personas into a unified persona; select between competing personas to identify a subset of possible solutions; and determine optimal solutions with respect to specific situations. The persona, combined personas, or group of personas may be utilized by an artificial intelligence engine to prioritize, filter, or otherwise weigh search results and to determine an impact of a preference on the overall score.

An entity may represent a human, corporation, or group that may have preferences with respect to a certain problem, a set of products, a scenario, a situation, or any combination thereof. An entity may either be virtual or real. The entity may represent a virtual entity, a person, a certain facet of a person (e.g., the user as a business person vs. the user as a family person), or a surrogate (e.g. an entity acting on behalf of an employer, a parent for a child, a guardian in a custodial relationship, a trustee on behalf of a beneficiary). A parameter is a specific set of rules, preferences, and priorities established by a user of a digital persona with respect to a defined situation or opportunity to decide among varied options.

A digital persona refers to a snapshot of information created by an artificial intelligence of any sort, e.g., machine learning, neural networks, evolutionary/genetic algorithms or other sorts, or a combination of some or all of these, to represent the preference and decision-making process of a represented entity. The digital persona can be used to mimic, replace, supplement or otherwise enhance human or other entity behavior.

Embodiments of systems, methods, devices and logical elements are described herein that utilize digital personas in conjunction with artificial intelligence (AI) engines to provide a solution to a problem, which may be in reaction to a user input, such as a query or other input (single occasion or over time), which may be proactively identified by the persona, or which may be a combination of solutions provided in reaction to user input and solutions proactively identified by the persona. Digital personas represent real-world entities within a digital universe of possibilities. A digital persona may learn and evolve over time, in response to implicit and explicit feedback, in response to changes in the digital universe, in response to its own experience and the experiences of other personas. Some examples provided herein reference the travel industry, which is a good example of how the systems herein can provide valuable decision-making capabilities; however, the travel industry is only one of many different sectors (industries) in which the systems and processes herein can be implemented.

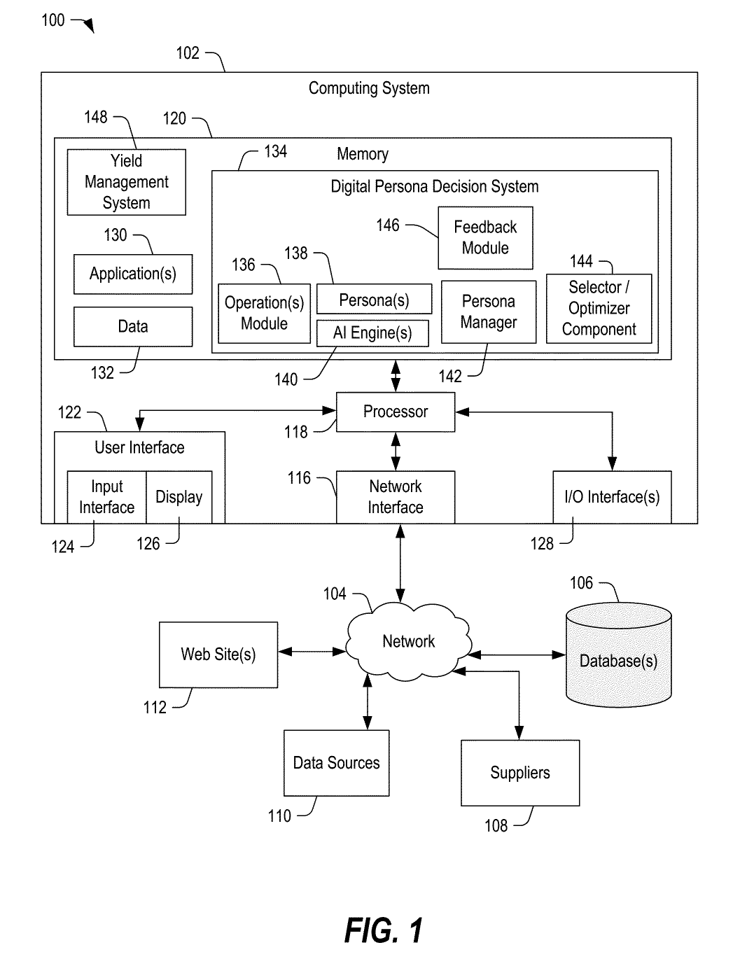

In some embodiments, the systems, methods, and devices described herein may be configured to receive feedback (explicit and implicit) with respect to a plurality of purchase options. In response to the feedback, the systems, methods and devices may be configured to automatically request further information, to automatically verify the further information, and to provide data related to the feedback to one or more suppliers. In some embodiments, the systems, methods, and devices may be configured to provide competing options from the one or more suppliers to a device in response to providing the data related to the feedback to the one or more suppliers. An example embodiment of a system configured to receive feedback is described below with respect to FIG. 1.

FIG. 1 is a block diagram of a system 100 including a digital persona decision system, according to certain embodiments. The system 100 includes a computing system 102 that may be configured to communicate with various devices and systems through a network 104, such as the Internet. In certain embodiments, the computing system 102 may communicate via the network 104 with one or more databases 106, one or more suppliers 108, one or more other data sources 110, one or more web sites 112, other data sources, or any combination thereof.

The computing system 102 may include a network interface 116 configured to communicate with the network 104. The computing system 102 may also include a processor 118 coupled to the network interface 116, to a user interface 122, to a memory 112, and to an input/output (I/O) interface 128. In some embodiments, the user interface 122 may include a display interface configured to couple to a display device and an interface (such as a Universal Serial Bus port) configured to couple to a keyboard, a mouse, or another input device to receive user input. In certain embodiments, the user interface 122 may include the input interface 124 and a display 126, such as a touchscreen device.

The memory 120 may include one or more non-volatile and volatile memory devices, such as a disc drive, a flash memory, cache memory, Random Access Memory (RAM), Read Only Memory (ROM), or any combination thereof. At least a portion of the memory 120 may include a non-volatile memory configured to store data 132 and to store instructions that may be executed by the processor 104 to perform a variety of functions and operations. The memory 120 may store one or more applications 130 and a digital persona decision system 134. The digital persona decision system 134 may include an operations module 136, personas 138, one or more artificial intelligence (AI) engines 140, a persona manager 142, and a selector/optimizer component 144.

The operations module 136, when executed by the processor 118, may cause the processor to receive data at an input and, after processing with other aspects of the digital persona decision system 134, provide an output including, for example, search results that have been ranked (scored), sorted, weighed individually or together, filtered, or otherwise processed according to a selected one of a plurality of personas 138. The personas 138 may be generated, modified, stored, and retrieved for use by the AI engines 140. Further, the personas 138 may include digital representations of individual consumers, groups of consumers, organizations, other entities, or any combination thereof.

The AI engines 140 may include instructions that, when executed, cause the processor 118 to apply a selected persona or more than one selected persona of the personas 138 to received queries, to received results from queries, or any combination thereof. The AI engines 140 may cause the processor 118 to process the data according to the selected persona(s) to rank the data, filter the data, or otherwise alter the data to provide a desired result that corresponds to a particular persona. The AI engines 140 may apply the selected persona to try to do what the user means rather than what the user says he or she means (i.e., to retrieve data corresponding to what the user intends to find or to the ultimate outcome the user is seeking to achieve). The AI engines 140 may also apply the selected persona to rank, sort, filter, or otherwise process received data. Additionally, the AI engines 140 may include at least one evolutionary function that, when executed, causes the AI engines 140 to process and update a persona over time, based on environmental factors, interactions of other personas, and so on. In particular, the AI engines 140 may rely on experiential learning over time. In certain embodiments, the AI engines 140 may assimilate numerous interactions by various personas, some of which may be similar to the selected persona, to learn experientially. The experiential learning process may involve analyzing persona interactions (explicit or implicit) with the “universe” of available options to generalize trends and other information, which may be used to adjust the selected persona, other personas, etc., and to make recommendations and assist in decision-making.

In certain embodiments, the AI engines 140 may include collaborative filtering, clustering, classification, frequent pattern mining, outlier detection, noise reduction, and other functionality implemented via distributed or scalable machine-learning algorithms, such as the Apache Mahout machine-learning project or other machine learning systems. Examples of the functionality and algorithms implemented by an Apache Mahout machine-learning system are described, for example, at http://web.cs.wpi.edu/˜cs525/s13-MYE/lectures/6/HadoopAnalytics.pptx; https://mahout.apache.org/users/recommender/recommender-documentation.html; and https://mahout.apache.org/users/basics/algorithms.html.

In certain embodiments, the AI engines 140 may include collaborative filtering, clustering, classification, frequent pattern mining, outlier detection, noise reduction, and other functionality implemented via systems that may be implemented using declarative rule-based systems, such as Drools or another rule-based management system. The AI engines 140 may be configured to process data (structured, unstructured, or semi-structured data) by filtering, clustering, classifying, weighing, correlating, performing any of the above-described functions, or otherwise processing the data. It should be appreciated that a persona may operate in conjunction with the AI engines 140 independent of a query. In certain embodiments, a persona may respond to events, or look out for needs and events where the persona may be required to do something or where the user should do or not do something in order to achieve a specific outcome. In certain embodiments, the persona may be configured to identify and present opportunities or solutions to a user proactively.

In some embodiments, the digital persona decision system 134 may include the persona manager 142 that, when executed, may cause the processor 118 to determine one or more personas from the personas 138 for use in connection with received data. The digital persona decision system 134 may further include a selector/optimizer component 144 that, when executed, causes the processor 118 to select between available results and to provide selected results to an output. In certain examples, the selector/optimizer component 144 may be presented with multiple multi-dimensional sets of search results, which may have been sorted, filtered, ranked, or otherwise processed by the AI engine 140 applying multiple selected personas 138. In an example, the results may be sorted, filtered, ranked, or otherwise processed using each of the multiple selected personas 138, providing search results ranked across multiple dimensions according to each of the personas, and the selector/optimizer component 144 may select one of the sets of ranked search results for providing as an output. In certain embodiments, the selector/optimizer component 144 may operate on opportunities, problems, outcomes, and event analysis in response to experiences and activities in the user's life and independent of any user query.

In certain embodiments, the selector/optimizer component 144 may select between the sets of search results based on data associated with a requesting device. In certain embodiments, the selector/optimizer component 144 may be configured to select a “best” representation of the results according to the available information about the user as represented by his/her persona at that point in time. In certain embodiments, the selector/optimizer component 144 may select a “best” representation of opportunities, problems, outcomes, and event analysis in response to experiences and activities in the user's life and independent of any user query, proactively providing a best representation of the possibilities according to the available information about the user as represented by his/her persona at that point in time.

In some embodiments, multiple digital personas may be engaged in making a decision when faced with varied options. In certain embodiments, the computing system 102 may implement a set of digital personas that compete among themselves to resolve a problem in order to achieve a solution that best mediates the interests of the user of the digital personas. In an example, the problem may be a search request. By allowing the multiple digital personas to impact the search and the processing of the results, the computing system 102 may produce multiple, varied result options, which can be compared and optionally processed by the selector/optimizer component 144. In certain embodiments, the selector/optimizer component 144 may select between the competing results or selectively combine results from the competing results. The computing system 102 thereby may achieve optimal results for that user.

In certain embodiments, data from requesting devices and data from data sources may vary widely from source to source, in terms of content, organization and so on. To effectively process data from multiple requesting sources and from multiple data sources, the computing system 102 may normalize the data and may operate on the data using AI engines 140 to produce queries directed to what the user really wants as opposed to relying solely on the keywords entered by the user. In certain embodiments, the computing system 102 may normalize the structured data (such as database data, labeled data, or preprocessed data), unstructured data (such as text documents and other text) and partly structured data (such as extensible markup language (XML) code, and so on). The computing system may translate such text, including the key words, into a homogenous language that may be integrated together to form a comprehensive blueprint of opportunities, solutions to problems, etc. In certain embodiments, the data may be normalized by extracting the data, transforming the data into a format suitable for a table, and loading the data into a table, where the table provides a temporary staging area for the data prior to further analysis and processing.

In some embodiments, the digital persona decision system 134 may further include a feedback module 146 that, when executed, may cause the processor 118 to receive feedback in response to a set of purchase options. Further, the feedback module 146 may cause the processor 118 to communicate with a device, such as a device associated with a user through the network 104 to receive information related to the feedback. In some embodiments, the information may include a digital image (screenshot), a link, text, or other information. The feedback module 146 may cause the processor 118 to communicate with one or more suppliers regarding the feedback, to receive competing offers and to communicate those competing offers to the device.

In some embodiments, the digital persona decision system 134 may communicate purchase option results and other data to the device. The digital persona decision system 134 may provide a graphical user interface (such as a web page) with user-selectable elements (such as buttons, tabs, checkboxes, radio buttons, clickable links, pull-down menus, and other elements). The graphical user interface may further include a feedback option, which may be accessible by a user to provide feedback with respect to the purchase options (individual results, globally, or both). Feedback received from interactions with the graphical user interface may be provided to the feedback module 146 for further processing. In some embodiments, the feedback may be received via free text, audio feedback, or other feedback. In some embodiments, audio feedback may be uploaded as a file, or may be provided in real time via a recording feature (not shown).

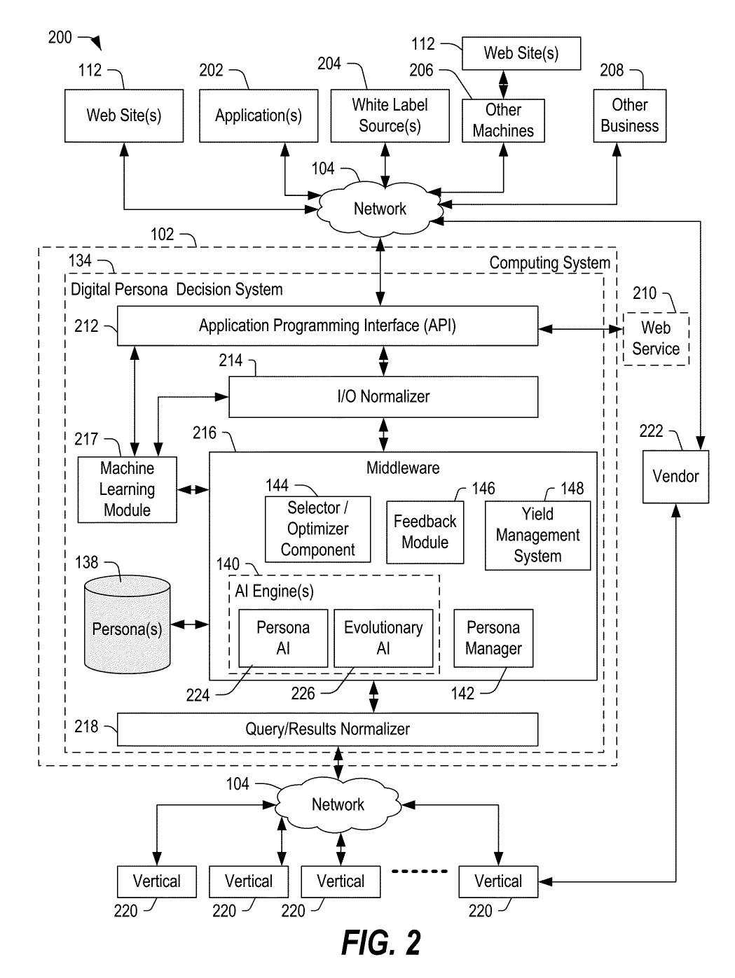

In some embodiments, the digital persona decision system 134 may communicate purchase options to one of the AI engines 140 implementing a selected persona from the personas 138. The feedback module 146 may receive feedback from the persona, automatically and with or without user input. One possible expanded view of the digital persona decision system is described below with respect to FIG. 2.

FIG. 2 is a block diagram of a system 200 including a digital persona decision system 134, according to certain embodiments. The system 200 may include the computing system 102, which may be configured to communicate with web sites 112, applications 202 (which may be executing on other computing devices), white label sources 204 (i.e., private label applications or services), other machines (e.g., other computing devices) 206, web sites 112 through one of the other machines 206, other businesses 208, vendors 222, or any combination thereof, through the network 104. Additionally, the computing system 102 may be coupled to one or more verticals 220 through the network 104. The term “vertical” may refer to a particular market sector, such as travel, financial, healthcare, real estate, entertainment, education, military, retail, grocery and produce, employment, etc. Each of the verticals, identified by 220, may include a plurality of websites, businesses, etc. that service that particular sector. Though each of the verticals 220 is depicted as a distinct entity, it should be understood that the verticals 220 overlap one another and that a business entity or website may cross multiple verticals, or sub-categories within one or more verticals (sub-verticals).

The one or more verticals 220 represent particular industry areas, business, business categories, and the like. In an example, one of the verticals 220 may be a travel vertical, which may include flight information, car rental information, hotel accommodations, vacation rental accommodations, train information, and so on. Another of the verticals 220 may include an information (research) vertical. Another of the verticals 220 may be a leisure activity vertical (e.g., concerts, live performances, plays, movies, parks, restaurants, golf, etc.).

In the illustrated example of FIG. 2, the computing system 102 is depicted as being coupled to two different networks, both of which are labeled 104. It should be understood that the networks 104, though separated, may be understood to be the same.

The computing system 102 includes the digital persona decision system 134. The digital persona decision system 134 may include an application programming interface (API) 212, which may be coupled to the web sites 112, applications 202, white label sources 204, other machines 206, other businesses 208, web services 210, vendors 222, or any combination thereof. The web services 210 may be part of the computing system 102 or may be associated with another device or system. The API 212 coordinates interactions between the computing system 102 and external components, devices, applications, etc. Further, the API 212 may receive data from the network 104 and may provide the data to an input/output (I/O) normalizer 214.

The I/O normalizer 214 translates received data into a format suitable for processing by the middleware 216. In certain embodiments, the I/O normalizer 214 may perform extract, transform, and load (ETL) functions using artificial intelligence. In particular, the I/O normalizer 214 may extract data from a received data stream, transform the data into appropriate formats (e.g., transform date information in a form of m/d/yy into a form mm/dd/yyyy), and load the data into a temporary table, which may be provided to the middleware 216. The normalization process may be performed automatically by a machine (the I/O normalizer) and may only utilize a minimal “mapping” effort with respect to placement of the data into the table.

The middleware 216 may include the selector/optimizer component 144, the AI engines 140, the persona manager 142, and the feedback module 146. The persona manager 142 may receive data from the I/O normalizer 214 and determine one or more personas from the personas 138 for use in connection with the received data. Additionally, the persona manager 142 may cause the processor to selectively execute a persona AI engine 224 (which applies selected personas to data), an evolutionary AI engine 226 (which may initiate changes in selected personas based on user interactions with the data, based on information derived from other personas, based on information derived from the “universe” of options, or any combination thereof), or a hybrid of both. The computing system 102 further includes a query/results normalizer 218, which may normalize a query, data, other information, or any combination thereof into data formatted for a particular one of the verticals 220.

In some embodiments, the persona AI engine 224 may receive feedback related to one or more of the options presented to a device. The feedback may include user feedback, automated feedback from a persona, feedback from another source, or any combination thereof. In response to the feedback, the persona AI engine 224 may communicate the feedback to the feedback module 146. The feedback module 146 may process the feedback and may communicate with the persona AI 224 to determine information about the feedback (such as information about a “better” option). In some embodiments, the feedback module 146 may provide data related to the feedback to the evolutionary AI 226, which may process the feedback to determine adjustments to one or more selected personas. In some embodiments, after receiving and validating the feedback, the feedback module 146 may be configured to communicate data related to the feedback to one or more suppliers (such as other businesses 208, vendors 222, web sites 112, white label sources 204, other suppliers, or any combination thereof) via the I/O normalizer 214 and the API 212. In some embodiments, the feedback module 146 may be unable to verify the “better” option based on the feedback. In some embodiments, the feedback module 146 may communicate data including a status of the verification, a reliability indicator related to the user's prior feedback or to the credibility of the user more generally, or any combination thereof. In an example, the feedback module may be unable to validate particular feedback, but may provide data to the suppliers such as “this feedback has been validated”; “this feedback has not been validated yet, but this user has a history of providing accurate feedback”; “this feedback has not been validated, and the user has a history of providing inaccurate feedback”; and so on. Thus, the feedback module 146 can provide feedback data and associated reliability information to the suppliers, which may utilize the information in determining whether to make a competing offer.

The API 212 may receive one or more competing offers from the suppliers, may communicate the competing offers to the I/O normalizer 214, which may process the competing offers into a suitable format for the middleware 216. The feedback module 146 may receive competing offers from the one or more suppliers in response to sending the data, and may communicate the competing offers to the persona AI 224, which may communicate one or more of the competing offers to the device from which the feedback was received. In some embodiments, a supplier may respond to the “better” purchase option without a competing offer, but with an explanation. In an example, the supplier may respond “We cannot beat this “better” option, but the “better” option may not be as attractive as it seems.” The “better” option may take longer, may involve a worse airline (in terms of user reviews, safety record etc.), or is not a “true” price because it has undisclosed taxes, fees, etc. or has major ancillary charges (e.g., luggage fees, etc.). In some examples, the “better” option may come with reduced reward points eligibility or no reward points eligibility. In some embodiments, the AI 224 may communicate the one or more competing offers with commentary or advice about them from the computing system 102 or recommendations between the competing offers if there are several.

In certain embodiments, a user may initiate a query via the web site 112, a mobile application, a business-to-business (B2B) connection, or any other front end device or system, and the query may be submitted to the computing system 102. The API 212 receives the query and provides the query to the I/O normalizer 214. The I/O normalizer 214 processes the query into a suitable format for the middleware 216. The middleware 216 may select one or more personas from personas 138 using the persona manager 142. The middleware 216 may also apply the selected persona(s) to the query using the persona AI engine 224 to perform query expansion, apply modifications or corrections to the query, and add constraints and refinements to the queries according to a selected persona to customize the query to the selected persona. The middleware 216 may provide the processed query to the query/results normalizer 218, which may normalize the processed query into suitable formats for one or more data sources associated with a particular vertical 220. The query/results normalizer 218 may then provide the processed and normalized query to one or more data sources associated with the vertical 220.

In certain embodiments, the options/solutions may be processed on a computing device such as a server and the results may be provided to a remote device, such as a laptop computer, a tablet computer, a desktop computer, a smart phone, or another data processing device. In certain embodiments, the computing system 102 may be implemented on a smart phone or other computing device, which may present options/solutions to a display.

In response to the processed and normalized query, the computing system 102 may receive results associated with the particular vertical. The query/results normalizer 218 may receive results from multiple data sources and may extract, transform, and load the results into one or more temporary tables, which may be passed to the middleware 216. The persona AI engine 224 may apply one or more selected personas from personas 138 to the results to produce one or more processed results. The processed results may be ranked, sorted, weighed, filtered, processed, or any combination thereof according to each of the one or more selected personas, potentially producing multiple multi-dimensional sets of processed results, which may be provided to the selector/optimizer component 144. The selector/optimizer component 144 may select one of the sets of processed results and may provide the selected one of the sets to the I/O normalizer 214, which may extract, transform, and load the data from the selected one of the sets of processed results into a format suitable for the API 212 to provide the results to a destination. The destination may be a device, an application, a web interface, etc.

In response to the results, the computing system 102 may receive feedback associated with one or more of the results. The query/results normalizer 218 may receive the feedback and may extract, transform, and load data from the feedback into one or more tables, which may be passed to the middleware 216. The personal AI 144 may provide the feedback to the feedback module 146, which may process the feedback data from the table, and may communicate the data to the evolutionary AI 226, to one or more suppliers, or any combination thereof. In some embodiments, the feedback module 146 may attempt to investigate the feedback, such as by reviewing the search results to determine if the “better” option was included in the original search results (but not presented to the user). Further, the feedback module may attempt to validate the feedback by attempting to find the “better” option at a third party or supplier website or by contacting the supplier. In still other embodiments, the feedback module 146 may be unable to immediately confirm or validate the “better” option, and may determine a “reliability” associated with the feedback, based on the user's feedback history or credibility more generally or based on the system that provided the feedback. In some embodiments, the feedback data provided to the evolutionary AI 226 and to one or more suppliers may include the reliability data.

When introduced with a problem, the I/O normalizer 214 may normalize the input and provide the input to the middleware 216. The middleware 216 can deliver specific facts and circumstances at hand to a persona AI engine 224 with selected digital personas from the personas 138, where each of these selected digital personas offers a potential solution in accordance with the following process: (1) the computing system 102 can produce a solution aligned with specific preferences and restrictions pre-established by the user within each digital persona; (2) the system can conduct a competition among the digital personas to determine optimal solutions for the user in the context of the specific facts and circumstances of each user request; and (3) the system can thereby resolve the problem presented by the user of the digital persona. The selected digital personas may be applied to the persona AI engine 224 to customize the persona AI engine 224, which customized AI may process the input data to adjust keywords, apply restrictions and query enhancements, and produce queries that are aligned with the specific preferences and restrictions associated with that particular persona. Such preferences and restrictions may be configured by a user, may be learned over time from explicit and implicit feedback from the user's interactions, may be inferred from interactions of various personas, or any combination thereof. The queries produced by the persona AI engine 224 based on each of the selected personas may be normalized by query/result normalizer 218 and may be sent to one or more data sources.

Each of the normalized queries produces results, and the results from each of the queries provides a basis for competition among the digital personas, which competition may be resolved by the selector/optimizer component 144 to determine optimal solutions for the particular problem. The results may be normalized by query/result normalizer 218 and provided (together with the associated persona) to the selector/optimizer component 144, which may select between the results or which may selectively combine the results from one or more of the sets of results to produce a set of search results, which may then be provided to normalizer 214 for normalization before transmission to a device. Throughout the process, the computing system 102 can intelligently track, collate, analyze, and record each solution, monitor user feedback (explicit and implicit), and thereby continuously learn the habits and behaviors of the user of the digital personas. The learned habits and behaviors may be used by the evolutionary AI engine 226 to refine the digital persona over time to achieve ever-more-effective results.

In certain embodiments, the computing system 102 uses unsupervised “deep” learning to learn about available options within the universe of options, to observe and learn from user interactions with that universe, and to refine or create a baseline persona associated with a particular category of users for a vertical 220 within the universe of options. The evolutionary AI engine 226 may modify the default or baseline personas within personas 138 based on such deep learning. Other personas (i.e., those representing individuals, corporations, etc.) may be understood as differences or deviations from the baseline persona for that particular category of entity. In an example, a persona associated with a user named Terry may be understood as a difference or delta between Terry's preferences, selections, and restrictions and those of the baseline persona. Since the baseline persona may evolve over time, twenty-four hours per day, based on interactions associated with every other persona in the system or based on interactions with the digital universe, Terry's persona benefits from the deep learning of the system without changing any parameters specific to Terry's persona. Thus, the computing system 102 evolves the individual's persona over time as its understanding of the universe of options evolves, and without losing the individuality of the user's persona. In particular, the persona AI engine 224 can selectively weigh the deltas of the user's persona relative to the baseline persona in order to dampen the impact of evolution of the baseline persona, particularly if there is an extended period of time between visits by the user.

In certain embodiments, the computing system 102 can implement searches (using the AI engines 224 and 226 and the personas 138) to fundamentally alter the user's experience. By utilizing personas, the computing system 102 may provide results, options, etc. that are tailored to the particular user, changing the experience from an episodic, non-experiential, and non-predictive experience to one that is tuned to the particular user through experiential learning. The user's persona in conjunction with the persona AI engine 224 makes it possible to provide an experience that is tailored to the particular user, predicting and providing what the user really wants and anticipating what the user may truly need, even if the user is not aware of those needs.

In certain embodiments, the user's persona can operate in conjunction with the persona AI engine 224 to provide a dynamic personalized intelligent search that yields the “best” for the user, with the user being split into the very essence of the user at that point in time taking into account what the user says he/she wants, what the user actually wants, where the user is, when the user is, what people are doing that the user trusts (such as friends, family, experts, etc.). Instead of assuming that there is only one user (which is what most people, websites, companies, etc. do), the system can recognize that a user may act differently and may make different types of decisions based on the context within which the decision is being made (e.g., time of day, individual's decision-making role (individual, employee, father, etc.), the date and its correspondence to upcoming events (birthdays, holidays, anniversaries, etc.), how the user is being impacted by the universe, and other context-based information.

In certain embodiments, the computing system 102 can be configured to look for “better” options/solutions, with the concept of “better” encompassing one or more factors (including a large number of factors), defined by the user, suggested by the system (automatically determined, suggested by people who the user trusts, or any combination thereof), or both. In certain embodiments, the computing system 102 may be configured to look for “better” proactively without being asked or based on a user action. In some embodiments, the persona AI 224 may hold or book the “better” option on behalf of a particular user, automatically and without being instructed to do so by the user. In some embodiments, the persona AI 224 may hold or book the “better” option either in connection with a set of rules or when the persona determines that such a “hold” or “book” option is a good idea. In some embodiments, the persona AI 224 may negotiate with a supplier on behalf of a user or may request a better option from a provider or from one or more suppliers where the “better” option does not already exist.

In certain embodiments, the computing system 102 may communicate with suppliers 108. A supplier 108 may utilize data from the system to learn that there is a demand for his/her product or a similar product. Further, the supplier 108 may also learn that the demand for the product or similar product exists at conditions similar to those at which the product was made available to consumers, but not identical to those conditions (i.e., different price, different color, different features, different quantity, projected delivery date, etc.). In some embodiments, the supplier 108 may learn that there is no demand for a particular product or a reduced demand for a product if certain attributes apply (such as a certain price, particular timing, and so on). The supplier 108 may also determine information about the person or persons requesting the product to determine the value of the person seeking the product, taking into account a broad value (category A) or narrow sub-values.

In a particular example, a first user may be a window shopper, always asking for “better”. The first user may say that he/she is interested in five star products, but for this first user it's really all about price. A second user may purchase about 30% of the time. The second user may be a total cheapskate, but may be an executive platinum consumer with that supplier. Further, the second user may be followed by many as a trendsetter, meaning that he/she starts and leads trends. A third user may purchase nearly all the time, but has no loyalty to any particular supplier, and has little or no price sensitivity. The third user may be an impulse shopper. The computing system 102 may dynamically determine the status of the first user, the second user, and the third user, which status changes over time. In certain embodiments, the computing system 102 may understand that the second user is of particular interest to the supplier who wants to keep the second user as an executive platinum level consumer. Further, the computing system 102 may recognize that the second user is also of particular interest to another supplier who wants to steal the second user because the second user is the “right sort of customer.” Thus, on the supplier side, the request for “better” or the suggestion of a desire for “better” (as a request may not actually have been made by the user) can yield a competition between suppliers 108 either for that user's business or that potential business. In some embodiments, the request for better may come as a result of feedback (such as the user finds a third party “better” option, the system finds a “better” option by continuously searching autonomously or in response to user instruction, and so on). In some embodiments, the supplier 108 may receive information about the user, which information may influence whether the supplier wishes to respond to the feedback, to the request for “better”, etc. The information may also influence how or in what way the supplier 108 may choose to respond, such as by providing an explanation of the “better” option, and so on. That competition may occur on the basis requested, such as $20 less than originally offered, or on different grounds, such as the same price as originally offered but with a free upgrade; the same price as originally offered plus bonus points; requested $20 cheaper but only able to offer $5 cheaper but will include breakfast; and so on. The response to the request for better or the suggestion of a desire for better can in turn yield behavior from the persona AI engine 224 (implementing the persona) on the consumer side, which may accept one of the offers, negotiate, specify a different “better” request, etc. This can be done with any type of inventory, upsell or cross-sell and could be done with any product in any industry, whether virtual or otherwise. In certain embodiments, the interactive nature of the system allows for a potentially infinite number of user/system communications and system/supplier communications and allows for multiple, potentially simultaneous conversations to provide product options or other types of options for the user.

The computing system 102 or platform may be configured to assess a “true” value of a product by itself, or on behalf of an entity (for example, a user, a supplier, a group, an organization, or any combination thereof) on a real-time basis. In some embodiments, “value” may be perceived as something that is mainly centered on a monetary amount, but the computing system 102 may apply a multi-dimensional assessment process that determines multiple values for a particular product, based on decisions made by other personas, expiration of the product, time, date, price, quantity, other factors, or any combination thereof. The combination of the multiple values provides an assessed value or determined value, which can be used to determine a “best” option, such as the option that provides a maximum “bang for the buck” for the entity.

In some embodiments, the normalizers 214 and 218 of computing system 102 may translate data from any source (in any format) to be useful and valuable to all users. The persona may utilize such data to gain insights from past interactions, habits, familial history, activities, providers, and more. Further, the normalizers 214 and 218 of computing system 102 may translate feedback data and competing offers from any source (in any format) into a format suitable for further learning by the evolutionary AI 226 and for communication between suppliers and a device, such as the device of the user who initiated the request.

While discussions herein include examples of healthcare and travel verticals 220, it should be understood that the computing system 102 may extend to any market or market segment or sector or other area of decision-making Examples of verticals 220 may include healthcare, real estate, retail, legal, military, financial, entertainment, food, education, and other markets. In certain embodiments, the systems described herein may utilize personas to provide a predictive search that may recommend alterations (e.g. trip alterations as to date/time/origination/destination city changes or other elements such as two one ways/multi-stop, etc.) to maximize value, to visit family, to bypass political situations, to avoid weather systems, etc.

In some embodiments, the systems described herein may utilize personas to provide group intelligence by combining users' searches, experiences, choices and results (through groups of personas) to apply new knowledge to future searches. In certain embodiments, the system may combine the multiple personas to produce one combined persona, which may provide solutions based on group intelligence. In certain embodiments, the system may utilize the multiple personas to generate multiple solutions, which may be selectively provided to the user based on selections made by the selector/optimizer 144.

In certain embodiments, the systems described herein may utilize personas to apply social, family and relational status to decision-making processes. In an example, the persona may recognize the familial/relational status of a traveler without status (i.e., a spouse, an employer, etc.) who has a direct influence on the non-traveling status holder (i.e., Platinum customer/member member), and may assist in making informed decisions to ensure a positive experience for the traveler. In some embodiments, the system may communicate with the supplier to provide information about a traveler without status, who may be connected to an important non-traveler with status. This notice may allow a supplier to adjust a product offering to the traveler without status in order to potentially enhance loyalty with the connected traveler with status.

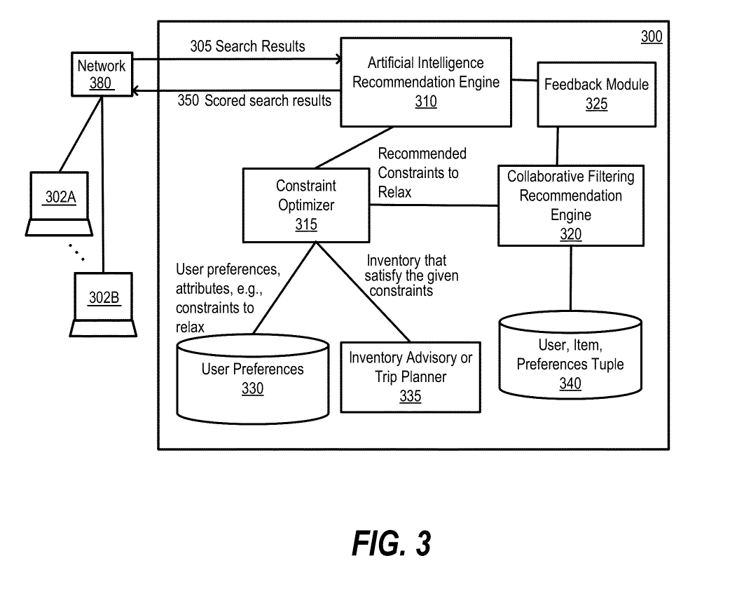

FIG. 3 is a schematic view of a search system 300 configured to search for travel arrangements and tickets. The search system 300 may include an artificial intelligence recommendation engine 310, a constraint optimizer 315, a database of user preferences 330, an inventory advisory engine 335, a collaborative filtering recommendation engine 320, and a user, item, preference tuples database 340 (e.g., a database of an ordered list of elements). The system 300 may couple to a network 380 and to one or more computing devices 302A and 302B, each of which may render a user interface, such as an Internet browser window, through which information from the search system 300 may be presented. The one or more computing devices 302A and 302B may include, for example, desktop computers, laptop computers, tablet computers, smart phones, other computing devices, or any combination thereof.

The computing devices 302A and 302B may include one or more applications, computer-readable instructions, and the like to allow interaction with the search system 300. The computing devices 302A and 302B may present interfaces including user-selectable elements, such as buttons, tabs, text fields, pulldown menus, and other input elements accessible by a user to enter information, such as search criteria 305. In some embodiments, an interface may include an option to receive freeform text, audio input, multi-media input, or any combination thereof. For example, the user interface may accept input from a user to initiate a search for goods or services at the artificial intelligence recommendation engine 310, including perishable goods or services. In an example, the computing device 302A may send data related to the search criteria 305 through network 380 to the artificial intelligence recommendation engine 310. The artificial intelligence recommendation engine 310 may generate scored search results 350 in response to the search criteria 305 and may send data including scored search results 350 to the computing device 302A via the network 380 for presentation within the user interface.

These scored search results 350 may be generated by the artificial intelligence recommendation engine 310 using information from the constraint optimizer 315. The constraint optimizer 315 receives data derived from the search criteria 305 (e.g., metadata) and may, in turn, re-direct the data to the collaborative filtering recommendation engine 320, and the inventory advisory engine 335.

Depending on the information, or metadata, that the artificial intelligence recommendation engine 310 has and passes on to the constraint optimizer 315 regarding the search and depending on the particular parameters used during this search, the constraint optimizer 315 can draw information from the database of user preferences 330, the collaborative filtering recommendation engine 320, the inventory advisory engine 335, other sources, or any combination thereof. The collaborative filtering recommendation engine 320 can in turn obtain information from the database with user, item, preference tuples 340 (e.g., an ordered list of elements).

For example, multiple personas in system 300 may be associated with a user or a device, and each persona may have different preferences associated therewith. Each persona can include information the user has provided, data collected by the system from past interactions with the user, inferred data determined by the artificial intelligence engines, data collected from other sources (such as social media), other data, or any combination thereof. In some embodiments, a user may have multiple, associated core personas. For example, the personas associated with the user may include a business traveler persona, a leisure traveler persona (for example, for trips away with the user's spouse or friends), a family traveler persona (for example, for trips with the spouse and children), and so on. In addition, there may be sub-personas, for example to differentiate a trip with the user's spouse from a trip with friends or to differentiate between a trip with the user's spouse with the kids or without the kids. The personas can be created by the user or can be suggested by the system based on user interactions. Each persona may correspond to different user needs, and each persona may be identified and used automatically.

The information including personas and the associated preferences can be stored on the user, item, preference tuples database 340 (e.g., a database of an ordered list of elements). The collaborative filtering recommendation engine 320 can take the search information that is passed to it from the artificial intelligence recommendation engine 310 via the constraint optimizer 315 and request additional information corresponding to the indicated persona from the user, item, preference tuples database 340. This information is returned to the constraint optimizer 315 to help generate search results on the artificial intelligence recommendation engine 310 that reflect the information collected from past interactions with the user from all of the personas, the particular persona being used in this search, or both, as well as secondary information such as the make-up of the user's family.

General user preferences, those which may apply regardless of the persona and which are received directly via user input, may be stored in the user preferences database 330. The constraint optimizer 315 can receive information from the artificial intelligence recommendation engine 310 and in turn return to the artificial intelligence recommendation engine 310 a short-list of search results based upon the user preferences in the user preferences database 330, results returned by the inventory advisory engine 335, as well as information regarding search constraints to relax from the collaborative filtering recommendation engine 320. The results returned by the inventory advisory engine 335 may include the search results returned by searches performed by other users previously for trips, or more generally, inventory that shares some, or all, of the same characteristics of the user's current search. When the search is for travel, previously identified travel inventory can include inventory in the same general vicinity and for about the same time-frame. In the example above, the inventory advisory engine 335 may have stored in it multiple, previously performed searches, and when a user searches for a trip from Tel Aviv to Houston, with the trip beginning on April 12 and ending on April 20, the inventory advisory engine 335 can return air fare results for trips to and from similar or nearby locations and on or around the same dates that resulted from previous users' searches.

In some embodiments, the inventory advisory engine 335 may provide multi-stop possibilities or may perform other more creative searches that other users may have performed. For example, another user trying to travel from Tel Aviv to Houston may have elected to fly from Istanbul instead and found another way to travel from Tel Aviv to Istanbul, such that the resulting flight and overall travel cost was significantly less than flying from Tel Aviv to Houston (even if there were multiple layovers).

The artificial intelligence recommendation engine 310 may examine the results returned from the constraint optimizer 315 to further compile a refined list of suggested search results that should appeal to the user, and thus return scored search results to the user via the computing device 302A or 302B via the network 380.

The search system 300 may further include a feedback module 325. When the scored search results 350 are sent by the artificial intelligence recommendation engine 310 to the computing device 302A (for example), the scored search results 350 may include data that, when executed, causes the computing device 302A to present a user interface including the search results and including multiple user-selectable elements accessible by a user to change the search criteria, to alter search preferences, to select one or more search options, and to optionally provide feedback. In some embodiments, the interface may allow a user (or an AI) to perform multiple searches concurrently (or in the same search), where the user may alter one or more parameters from one search to the next, allowing the user to see how such changes may impact search results, price, product offerings, etc. In response to selection of a feedback element, the computing device 302A may communicate data related to the feedback to the artificial intelligence recommendation engine 310, which may provide the feedback data to the feedback module 325. The feedback module 325 may process the feedback data and may provide information to the artificial intelligence recommendation engine 310 and to the collaborative filtering recommendation engine 320 to update filters and persona information as well as to identify other possible purchase options for presentation to the computing device 302A. In some embodiments, the feedback module 325 may communicate data related to the feedback to one or more suppliers to provide an opportunity for those one or more suppliers to provide competing offers. In a particular example, the user may interact with the feedback element within a user interface on the computing device 302A to indicate that he/she found a better purchase option. The feedback module 325 may cause the artificial intelligence recommendation engine 310 to communicate with the computing device 302A to gather more information about the “better” purchase option. In some embodiments, the feedback module 325 may analyze the “better” purchase option to determine differences between the “better” purchase option and the scored search results 350 and may utilize data related to the differences either to determine other purchase options or to re-score the searched results 350. The resulting purchase options may then be presented to the computing device 302A.

In some embodiments, the feedback module 325 may communicate data related to the feedback to relevant suppliers (i.e., flight feedback to air travel suppliers, etc.). In some embodiments, the feedback module 325 may provide data related to the feedback to particular suppliers. For example, the feedback module 325 may provide the competing option opportunity to preferred suppliers rather than all suppliers who could compete on that product. In some embodiments, the feedback module 325 may provide data related to the feedback to a yield management system, which may provide a better product or option itself, without any need for action by any supplier, for example, by cutting its commission to provide a better price or by sourcing a new supplier to provide the product or products it was missing.

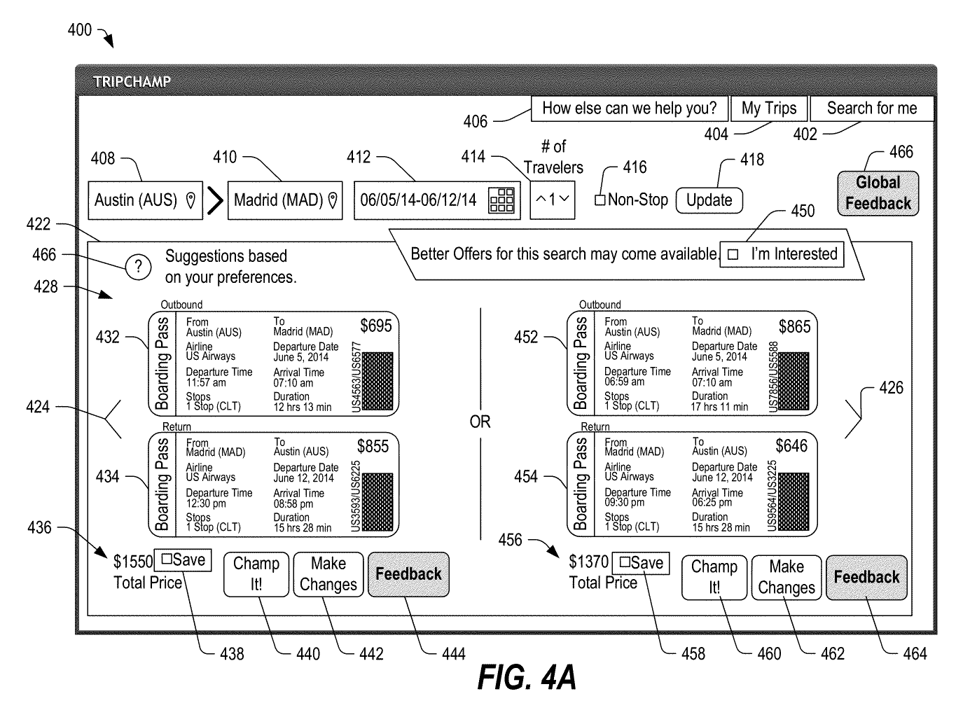

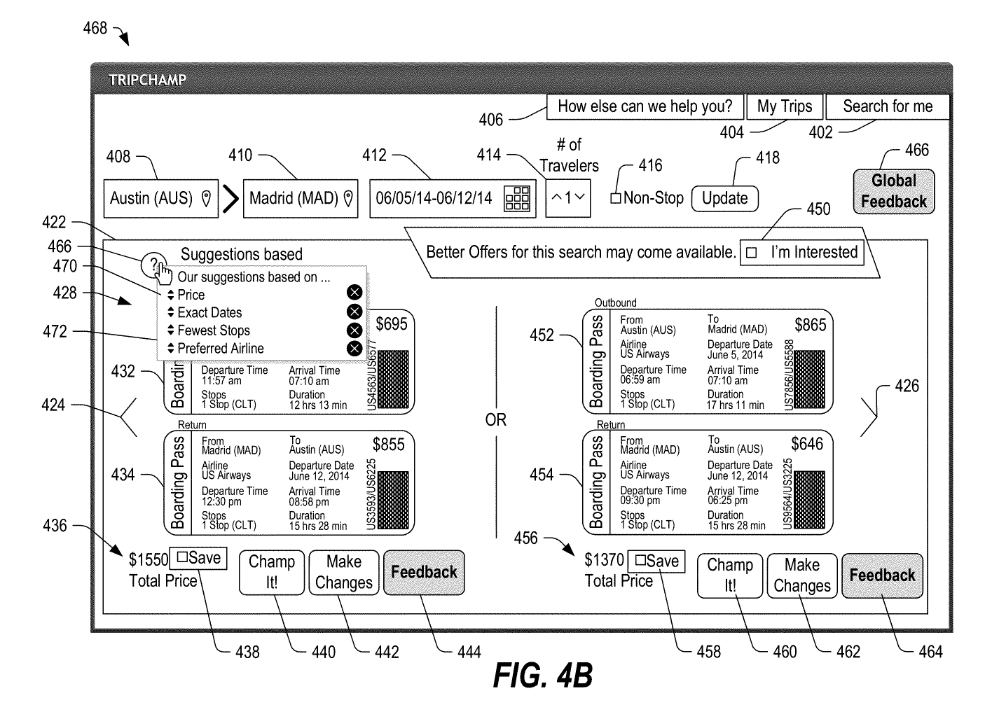

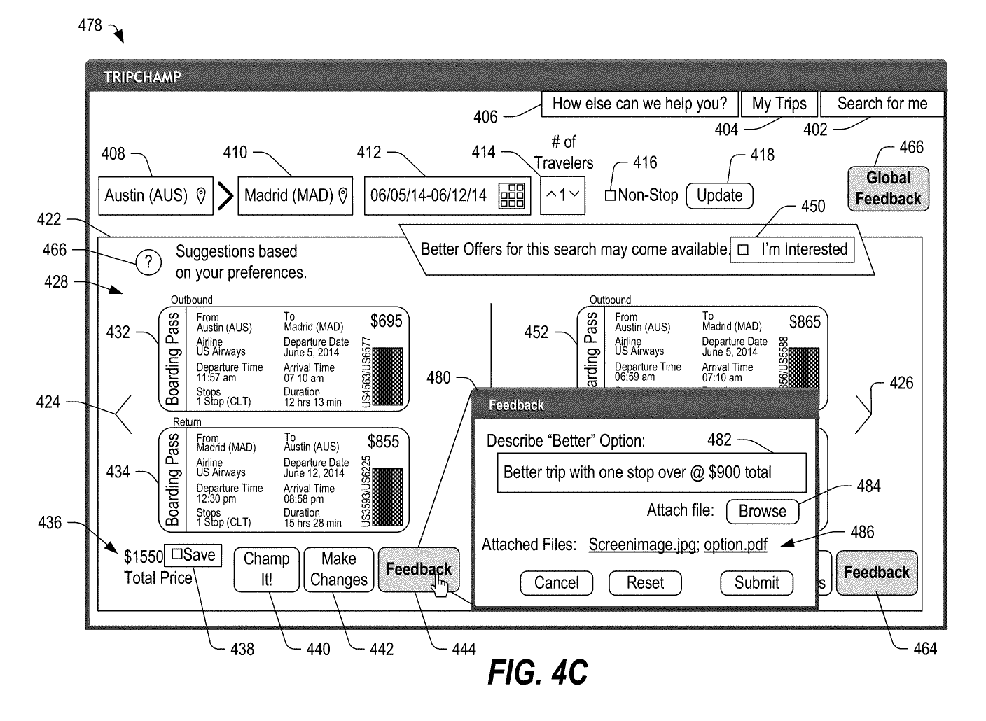

FIGS. 4A-4C depict a representative example of a user interface 400, which may be presented on computing device 302A or 302B in FIG. 3 or on a computing device configured to communicate with the computing system 102 in FIGS. 1 and 2. In this view of the exemplary user interface 400, a user is searching for a trip starting at Austin, Texas to Madrid, Spain and back again from June 5 until June 12, 2013. In some embodiments, the user interface 400 may allow for multiple searches and search refinements in a single search and without having to conduct completely new searches. Further, in some embodiments, the user interface 400 may allow a user to hold some search results while conducting further searching or refinement operations to assemble a set of search results for review by the user. In a particular embodiment, the user interface may allow a user to alter selected variables in a single search, such as a stopover flight location, a duration, and so on.

FIG. 4A is an example of a user interface 400 including a plurality of user-selectable elements. The user interface 400 may include a tab or button 402 (labeled “Search for me”), which may be accessed by a user to initiate automated searching by the search system. The user interface 400 may also include a tab or button 404 (labeled “My Trips”), which may be accessed by the user to view previous trips and to view upcoming trips arranged via the system. The user interface 400 may also include a tab or button 406 (labeled “How else can we help you?”), which may be accessed by the user to provide further requests that can be acted on by the system.

The user interface 400 may include an origin field 408, a destination field 410, a date range field 412, a pull-down menu 414 indicating a number of travelers, a checkbox 416 corresponding to a non-stop flight selection, and a button 418 (labeled “Update”). The fields 408, 410, and 412, the menu 414, the checkbox 416, and the button 418 may be accessed by a user to alter the search parameters. The user interface 400 further includes a results pane 422, which may include purchase options 428. In this example, the results pane 422 may include a first roundtrip flight including an outbound option 432 and a return option 434. Further, associated with the first roundtrip flight, the results pane 422 may include a total price 436 and a checkbox 438 (labeled “Save”), which may be accessed by a user to save this particular purchase option in the set of options. In some embodiments, selection the checkbox 438 may cause the user interface 400 to add the roundtrip flight to a list of possible options. The results pane 422 may also include a button 440 (labeled “Champ It!”) that can be accessed to provide positive feedback indicating that the particular roundtrip flight meets the user's needs or to vote for a particular roundtrip option. The results pane 422 may also include a button 442 (labeled “Make Changes”) that, when accessed, may cause the user interface to present one or more selectable options for adjusting the search parameters or for adjusting the prioritization of the results presented in the results pane.

In an alternative embodiment, the interface 402 may include embedded data from the search results, may include embedded scripts, and may include additional selectable elements that, when selected, may allow a user to selectively change one parameter of the search without altering other parameters. In response to the selection, the interface 402 may update the search results presented within the results pane 422 in real-time, for example, without performing a new search. Concurrently, the interface 402 may communicate the data to the computing system 102, and the computing system 102 may perform one or more searches based on the changed parameters. The computing system 102 may weigh the results using the AI engines 140 configured with one or more selected personas.

The results pane 422 may further include a button 444 (labeled “Feedback”), which may be accessed by a user to provide feedback with respect to the first roundtrip flight including outbound portion 432 and return portion 434. In some embodiments, in response to selecting the feedback button 444, the interface 400 may provide a popup window or may open a new interface or page through which a user may provide details related to a better option.

The purchase options 428 may include a second roundtrip flight including an outbound option 452 and a return option 454. Further, associated with the second roundtrip flight, the results pane 422 may include a total price 456 and a checkbox 458 (labeled “hold”), which may be accessed by a user to hold this particular purchase option in the set of options. In some embodiments, selection the checkbox 458 may cause the user interface 400 to add the roundtrip flight to a list of possible options. The results pane 422 may also include a button 460 (labeled “Champ It!”) that can be accessed to provide positive feedback indicating that the particular roundtrip flight meets the user's needs or to vote for a particular roundtrip option. The results pane 422 may also include a button 462 (labeled “Make Changes”) that, when accessed, may cause the user interface to present one or more selectable options for adjusting the search parameters or for adjusting the prioritization of the results presented in the results pane. In some embodiments, the results pane 422 may include a button or link accessible to discard or otherwise trash a particular option.

The results pane 422 may further include a button 464 (labeled “Feedback”), which may be accessed by a user to provide feedback with respect to the first roundtrip flight including outbound portion 462 and return portion 464. In some embodiments, in response to selecting the feedback button 464, the interface 400 may provide a popup window or may open a new interface or page through which a user may provide details related to a better option. In some embodiments, the results pane 422 may allow for feedback for each individual itinerary, for each leg of a potential itinerary, for all of the results (global feedback button 466), or any combination thereof.

In some embodiments, the interface 400 may include a checkbox 450 that, when selected, may cause the interface 400 to communicate data to the computing system 102, to configure the computing system 102 and to continuously search for better options or offers that may come available for a period of time until a date expires that is specified by the user. In some embodiments, such as a purchased flight or an event, the computing system 102 may have a deadline (date/time) that may define a period of time within which the computing system 102 may continuously search for “better” options. Once the day/time of the flight or event arrives, the computing system 102 may cease searching for a better option, at least with regard to the first leg of the flight or at least with regard to a first portion of the event. In response to user selection of the checkbox 450, the computing system 102 may continue to search, even after a user has made a purchase, to identify potentially better travel options (in terms of duration, price, and other parameters). In the context of other types of searches (e.g., product searches), the computing system 102 may continue to search for “better” and may provide alerts to the user when potentially “better” options are found together with explanations of why they are better or worse and advice. Unlike traditional alerts, the computing system 102 may include a real-time link to the “better” option or product, allowing a user to select the link to buy the “better” option. In some embodiments, the alert may provide an explanation about why the computing system 102 can't find a “better” option, such as the time of year, the price was already great compared to normal pricing, etc. In some embodiments, the alert may also suggest a course of action, such as notifying the user that the particular option is the best option available and is likely to remain the best available. The alert may also recommend that the user book this option and may automatically book the option if authorized to do so by the user either in the specific instance or generally or if certain criteria imposed by the user are met. In some embodiments, the computing system 102 may hold or save the option, when allowed to do so by the supplier, if the option is likely to disappear quickly or before a user can respond (such as when the option arrives late at night).

In the example search for a fare round-trip between Austin and Madrid, the origin of the trip, Austin, may be depicted in the origin field 408, and the destination of the trip, Madrid, may be depicted in the destination field 410. The origin field 408 and the destination field 410 can receive typed input or can receive input through user-selection from a list or a map or via voice. Further, if a portion of one of the itineraries, such as the outbound flight 432 is a good option for the consumer, but the return flight 434 is not, the consumer may select the make changes button 442 to selectively alter one portion of the itinerary in order to explore alternative options.

In certain embodiments, the consumer may alter portions of the itinerary without altering other portions and without having to re-initiate the search process. The computing system 102 may determine the flight information in the background and on the fly in response to such changes. In some embodiments, the results pane 422 may include a selectable element 466 that, when selected, may provide information regarding the user's preferences upon which the itineraries were ranked or selected for display. In some embodiments, selection of the selectable element 466 may cause a popup window or menu to be displayed from which a user may selectively alter the preferences. An example of an interface including an interface for such configurable parameters is described below with respect to FIG. 4B.

FIG. 4B is an example view of the user interface 400 of FIG. 4A, generally indicated at 468, and including a popup menu 470 allowing adjustments to bases for the suggested results, in accordance with certain embodiments of the disclosure. The popup menu 470 includes parameters upon which the suggested results are organized and selected. In some embodiments, the popup menu 470 may include a price parameter, an exact dates parameter, a fewest stops parameter, a preferred airline parameter, other parameters, or any combination thereof. To the left of the menu option may be an up/down arrow that allows the subscriber to alter a priority ranking of the various parameters by moving a selected parameter up or down within the list of parameters, which adjustment may alter the ordering of search results within the results pane 422. Further, to the right of the menu option may be an “x” or other selectable element accessible to remove a parameter from the set of parameters by which the results were ordered. Changes to the parameter popup menu 470 may impact the results shown in the results pane 422.

As mentioned above, if the user wants to remove criteria from consideration, he or she can remove it from the list, for example, by using the buttons on the right hand side of the list shown. When the user wants to change the importance of a category, he or she can move the category up or down on the list, such as by using the arrows on the left hand side of the list. The preferences that the user has for criteria can be defined on other pages that can be reached using the navigation buttons 402, based upon information supplied when creating a user persona, based upon past behavior associated with the user persona, or any combination thereof. In other embodiments, the interface 468 may allow a user to swipe one direction to delete an option and another direction to save the option. In other embodiments, the user may interact with the user interface 468 or may communicate with the system to specifically identify what he or she likes or dislikes, the system may populate or adjust the preferences 470 from its understanding of the user.

FIG. 4C is an example view 478 of the user interface 400 and 468 of FIGS. 4A and 4B and including a popup window 480 to receive information about a “better” option, in accordance with certain embodiments of the disclosure. The user interface 478 includes all of the elements of FIGS. 4A and 4B. Further, in response to user selection of the feedback button 444, the user interface 478 may open a popup window 480, which may include a text field 482 accessible by a user to describe a “better” option. The popup window 480 may also include a browse button 484 accessible by a user to browse for files to attach, and may include a list of attached files 486. In some embodiments, the popup window 480 may provide a provision for capturing audio feedback, such as a voice. The user may activate the popup window 480 and may visit another site to find a “better” option than what was presented in the results pane 422. The user may describe the better option via voice.

A user may interact with the feedback button 444 to provide an indication that the particular itinerary in the results pane 422 is less than satisfactory. In some embodiments, the user may provide an indication that he or she found a better option, and may interact with the feedback popup window 480 to describe one or more better options via text field 482 and to attach evidence (such as an image or audio feedback) via a browse button 484. In some embodiments, the better option may be a private option that may not be available to third party search sites, but which may be available by contacting the supplier directly.

In some embodiments, the interface 478 may include one or more “better” options determined by an expert or a person of trust to the consumer, rather than the consumer himself or herself. The “better” options may be provided in any number of file formats, including Joint Photographic Experts Group (JPEG), portable document format (PDF), graphics interchange format (GIF), tagged image file format (TIFF), bitmap, other file formats, or any combination thereof. The feedback interface 480 enables a user to enter feedback regarding a “better” trip option known to the user and to submit the feedback to the computing system, where, as described above, the feedback may include text, images, links, audio files, or any combination thereof. However in some instances, the better option may be found by an expert or by someone the user trusts and may be communicated in the same way.

In the above-discussion, feedback buttons 444 and 464 were discussed. However, in some embodiments, the feedback process may be initiated by swiping (dragging a mouse, pointer, or finger (in the case of a touchscreen) across one of the itineraries in a first direction. In some embodiments, in response to such a swiping motion, the user interface 402 may provide the feedback popup 480.

In some embodiments, in response to the feedback, the virtual purchasing assistant may attempt to verify the “better” option and may communicate with the supplier with respect to the feedback. The communication may include information about the allegedly “better” option, as well as information about the verification status of the feedback, information about the user providing the feedback, other information, or any combination thereof. In some embodiments, the virtual purchasing assistant may receive competitive options (competing offers) in response to the feedback and may provide the options to the device. In some embodiments, the competing offers may include other itineraries, combination offers (e.g., flight plus upgrade, etc.), and so on. A competing offer may include an offer that competes on at least one parameter (such as price or some other parameter). In some embodiments, the yield management system 148 of the computing system 102 may receive the feedback and may provide one or more competing offers. In some embodiments, the yield management system 148 may reduce a price of a particular purchase option by reducing its commission in order to provide a competing offer. In some embodiments, instead of providing a competing offer, a particular supplier may respond to the feedback by providing a comment regarding the feedback, by providing advice associated with the “better” option included in the feedback, by providing an explanation for why the supplier is not able to “beat” the “better” option or why the “better” option is not as good as it might seem, or any combination thereof.

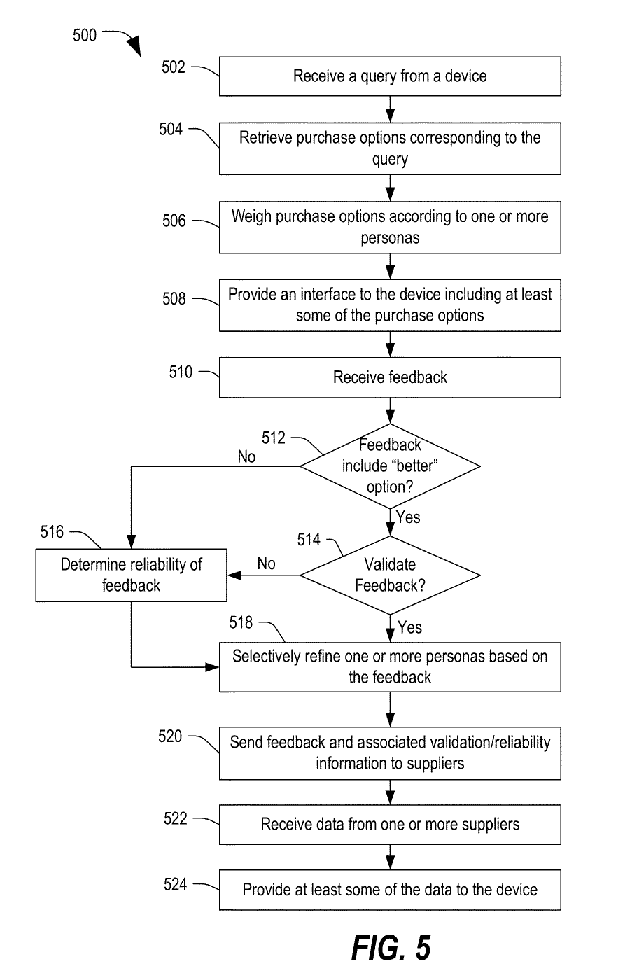

Referring to FIG. 5, a flowchart of a method for providing purchase feedback is generally shown at 500. The method 500 may include receiving a query from a device, at 502. The query may be received from a device associated with a user, a device acting on behalf of a persona, another device, or any combination thereof. In some embodiments, a consumer may initiate the query by interacting with an interface associated with an electronic device or a web page provided by the computing system 102. In some embodiments, the AI platform may initiate the query.

Further, in response to receiving the query, the method 500 may include retrieving one or more purchase options corresponding to the query, at 504. In some embodiments, the computing system 102 may normalize the query and search one or more data sources including local data sources, the yield management system 148, supplier data sources, or any combination thereof. The computing system may receive one or more purchase options from one or more of the data sources, immediately, after a brief search period, over time, or any combination thereof. In some embodiments, the method 500 may include contacting the yield management system 148 in response to receiving the query. In some embodiments, the method 500 may include searching one or more data sources, including vendor sites, a vendor aggregated and normalized repository, and other sites based on the query to identify possible itinerary options.

At 506, the method 500 may include weighing the purchase options according to one or more personas. In some embodiments, the computing system 102 may select one or more personas 138 from the memory 134 based on login information, other information, or any combination thereof, and may configure the AI engine 140 using the selected persona(s). The configured AI engine 140 may process the purchase options to weigh each purchase option according to the preferences indicated by the selected personas.

At 508, the method 500 may include providing an interface to the device including at least some of the purchase options. In some embodiments, at least some of the weighted purchase options may be provided within the interface. In some embodiments, the interface may be a web page provided by the computing system 102 and rendered within an Internet browser of the device or within an application interface of an application executing on the device.

At 510, the method 500 may include receiving feedback. The feedback may be related to one or more of the purchase options. In some embodiments, the feedback may be related to a particular parameter of a single purchase option. At 512, if the feedback does not include a “better” option, the method 500 may include determining reliability of the feedback, at 516. In some embodiments, the reliability may be determined by searching data from the search results, searching data from the yield management system 148, searching data from one or more suppliers, searching data from one or more other sources, or any combination thereof. The reliability may also be determined by retrieving data about the consumer or device providing the feedback. If, for example, the consumer has previously given feedback that turned out to be correct, the reliability may be determined based on the consumer's prior history. Other bases for determining the reliability may also be used.

At 512, if a “better” option is provided as part of the feedback, the method 500 may attempt to validate or verify the feedback, at 514. In some embodiments, validation may be performed in a fashion that is similar to the determination of the reliability. In some embodiments, the “better” option may be validated by searching data from the search results, searching data from the yield management system 148, searching data from one or more suppliers, searching data from one or more other sources, or any combination thereof to attempt to find the “better” option. If at 514, the “better” option cannot be validated, the method 500 may determine the reliability of the feedback, at 516.

Otherwise, if the “better” option is validated at 514, the method 500 may selectively refine one or more personas based on the feedback, at 518. In some embodiments, refining the personas may include providing data related to “better” option and other implicit or explicit feedback data to an evolutionary AI engine, which may alter one or more parameters of a persona based on the information. In some embodiments, the method 500 may also include refining or adjusting search logic in order to find the “better” option (or similar options) in the future.

At 520, the method 500 may include sending the feedback and associated validation/reliability information to suppliers. In some embodiments, the feedback and associated information may be provided to all suppliers. In some embodiments, the feedback and associated information may be provided to a yield management system. In still other embodiments, the feedback and associated information may be provided to selected suppliers, to the yield management system, or any combination thereof. In other embodiments, the feedback and associated information may be provided first to at least one of the yield management system and one or more preferred suppliers. The feedback and associated information may then be provided to other suppliers. Other embodiments are also possible.

At 522, the method 500 may include receiving data from one or more suppliers. In some embodiments, the data may include competing offers, comments related to the “better” offer, other information, or any combination thereof. In some embodiments, the one or more suppliers may include the yield management system.

At 524, the method 500 may include providing at least some of the data to the device. In some embodiments, a portion of the data may be provided to the device, and some of the data may be filtered out based on one or more personas associated with the device. In some embodiments, a first subset of the competing offers may be provided to the device, and other competing offers may be withheld, pending the user's response.

In some embodiments, the data provided to the device may include competing or competitive options, which may represent purchase options that may be competitive in terms of price, upgrades, options, other details relative to the “better” purchase option, or any combination thereof. Thus, suppliers may be able to compete for a consumer's business by reviewing a “better” option and by providing competing options, which may be chosen by the consumer. The competing (“competitive”) options may compete on any number of parameters. In travel, for instance, the competing options may compete on price, duration, upgrades (i.e., business class versus coach), number and duration of layovers, timing, mileage eligibility, change fees, and so on. In some embodiments, the one or more suppliers may take steps to reduce the rate on a private/discrete basis to compete with respect to a better offer. In some embodiments, the system may host a chat or other bi-directional communication to facilitate communication between the supplier and the potential purchaser. In some embodiments, a negotiator BOT may negotiate between the supplier and the purchaser. The hosted chat or bi-directional communication, whether between the user and the supplier, the negotiator BOT and the supplier, or the negotiator BOT acting as the purchaser and as the supplier, may potentially include endless back and forth communications. Within the hosted communication link, the device may respond to one or more of the competing offers and the suppliers may respond to the response, and so on. The hosted communication link may facilitate the purchaser and the supplier achieving a best possible outcome for one or both parties.

In some embodiments, the system may be configured to handle any better offers that, when they are received, automatically reverse or change the pricing structure/offering and impose formulas to automatically assess and decide how to respond to each “better” offer (whether using rules or otherwise) and that learns from how effective the competing offers and decisions are in realizing sales, revenue, loyalty or other factors (or goals) and avoiding price degradation, market disruption, and the like.

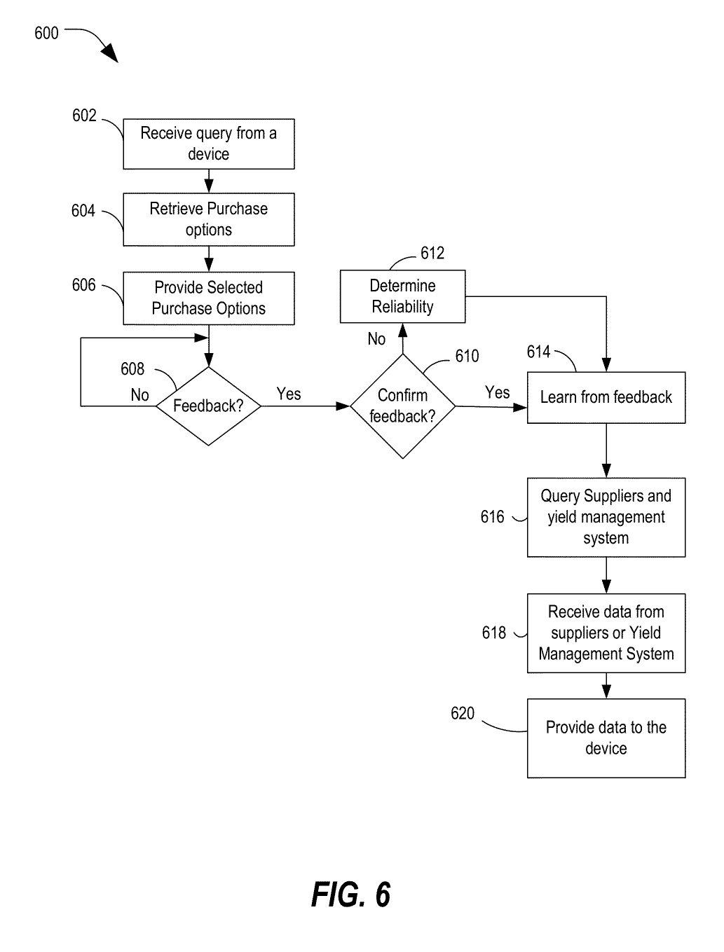

Referring to FIG. 6, a flowchart of a method of responding to purchasing feedback is shown and generally designated 600. At 602, the method 600 may include receiving a query from a device. The query may include an indication of one or more desired parameters and information related to a product or purchase option. In the case of a travel purchase, the parameters may include departure location, departure date, destination, return date, times, price information, other parameters, or any combination thereof.

At 604, the method 600 may include retrieving one or more purchase options corresponding to the parameters. The purchase options may be retrieved from a plurality of data sources. At 606, the method 600 may include providing selected purchase options to a device. In some embodiments, the method 600 may include sending data including one or more of the purchase options to a device through a network communications link, and the device may process the data and may present the data to a display, such as within an Internet browser window, an interface of an application, or some other interface. In some embodiments, the data may include a graphical user interface including one or more user-selectable elements with which a consumer may interact to select, change, or provide feedback corresponding to one or more of the purchase options. In some embodiments, the search system may provide selected results to the device, which selected results may be determined by the AI engine configured according to one or more selected personas.

In some embodiments, the user may interact with a feedback element associated with the graphical user interface to provide feedback regarding the purchase options. In some embodiments, in response to selection of a feedback button or other element, the graphical user interface may provide an input option through which a consumer may communicate a “better” purchase option than those presented. The feedback may include text, images, video, freeform text, audio data, or any combination thereof.

At 608, if feedback is not received, the method 600 may continue to wait for feedback. Otherwise, the method 600 may confirm the feedback, at 610. In some embodiments, the feedback may be confirmed by checking search results, by searching one or more data sources, by receiving documentation from the user, or another method. If the feedback is confirmed at 610, the method 600 may advance to 614 and the method 600 may include learning from the feedback. In some embodiments, learning may include determining a new source for supply options, updating search parameters to search that source in the future, and so on. In some embodiments, learning may also include updating parameters associated with the consumer to better predict what the consumer might find to be a “better” option, based on parameters of the “better” option. In some embodiments, the method may be implemented on a computing system, which may be configured to attempt to determine what parameters of the “better” option make the particular option “better” for the consumer. In some embodiments, the computing system may update a persona associated with the consumer based on the feedback. In some embodiments, the supplier may not be known to the system, and the computing system may store information about the supplier in memory.

At 610, if the feedback cannot be confirmed or if the feedback cannot be confirmed quickly, the method 600 may determine the reliability of the feedback 612. The reliability may be determined based on the source of the feedback or based on other information. The validity or confirmation of the feedback or the reliability of the feedback may be provided to a learning module.

At 614, the method 600 may include learning from the feedback. In some embodiments, a machine learning module may process the feedback to learn about the user selections and to adjust prediction parameters to better predict choices that a consumer may make.

At 616, the method 600 may include querying suppliers and the yield management system. As discussed above, in some embodiments, one or more preferred suppliers may be queried. In some embodiments, one or more suppliers and the yield management system may be queried first, and then other suppliers may be queried. Other embodiments are also possible.

Continuing to 618, the method 600 may include receiving data from the suppliers, the yield management system, or any combination thereof. The data may include competing offers. In some embodiments, the data may include an explanation from a supplier about why the supplier is not providing a competing offer or an explanation about why the “better” option is not as good as it seems. In some embodiments, the data may also include recommendations, images, text, video, audio, or other information.

At 620, the method 600 may include providing data to the device, such as a device associated with the requesting device. In some embodiments, the method may include providing a portion within a graphical user interface or other interface provided to the device.

In some embodiments, the feedback, at 608, may be received from a device that is associated with an AI engine, rather than a consumer. In some embodiments, the AI engine may be configured to act as an automated agent, which may interact with the search system as a consumer might, but the automated agent is a digital representation of the consumer. In an example, an artificial intelligence agent configured with a selected persona may operate as a virtual customer to use the system to compare the results with other systems. The computing system may update and refine its offerings based on the feedback from the AI agent.

In some embodiments, in response to receiving purchase option feedback, one or more personas may be updated. For example, when a consumer returns a “better” purchase option as feedback, the system may first determine if the “better” purchase option was originally retrieved by the system but not provided to the consumer. If the “better” purchase option was located by the system, but passed over for presentation to the consumer based upon a consumer preference determined from one or more personas, the system may update one or more of the personas associated with the consumer based on the “better” purchase option. For example, a persona associated with the consumer may be updated to indicate a preference for a property or aspect of the “better” purchase option. Thus, a persona may evolve over time.

In a particular example, the “better” purchase option returned by a consumer may include a trip having plane and train components, whereas other purchase options provided to the consumer may have included only plane-based travel options. In response to the consumer providing a “better” purchase option that includes both plane and train components, the system may update the persona associated with the consumer.

If, however, the “better” purchase option was not located by the system, then there may be no reason to update a persona, particularly if the “better” purchase option would have been presented to the consumer if the “better” option had been located by the system. Alternatively, if the “better” option can be verified but was not part of the search options known to the system, the system may be updated to “learn” the supplier, thereby expanding the offerings for the system in the future.

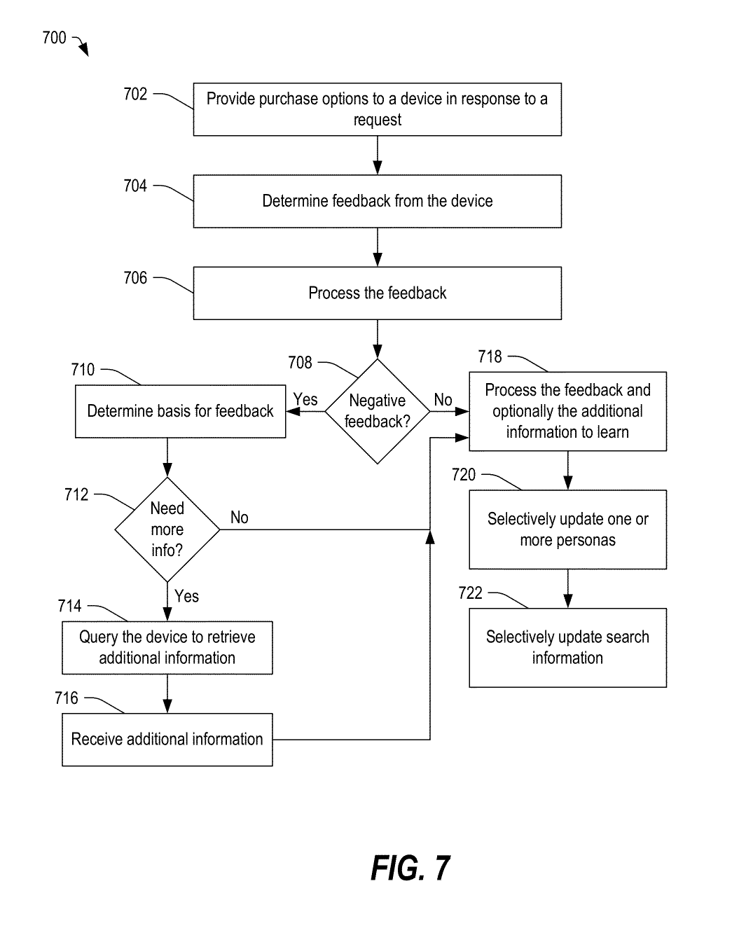

Referring now to FIG. 7, a method of responding to feedback is disclosed and generally indicated at 700. The method 700 may include providing purchase options to a device in response to a request, at 702. In some embodiments, the request may be sent by a consumer via his or her device or may be sent by a digital agent representing a consumer. The request may specify one or more parameters of a product to be purchased.

At 704, the method 700 may include determining feedback from the device. In some embodiments, the feedback may be determined from explicit feedback or inferred from implicit feedback (such as time spent on an option, failure to close a sale, and so on). In some embodiments, the feedback may include explicit feedback coupled with information about a “better” option. At 706, the method 700 may include processing the feedback.

Advancing to 708, if the feedback is negative, the method 700 may include determining the basis for the feedback, at 710. If more information is needed at 712, the method 700 may include querying the device to retrieve additional information, at 714. At 716, additional information may be received. In response to receiving the additional information, the method 700 may include processing the feedback and optionally the additional information to learn, at 718. In some embodiments, such learning may be a machine learning process.

Returning to 712, if more information is not needed, the method 700 may advance to 718, and the method 700 may include processing the feedback and optionally the additional information to learn. Returning to 708, if the feedback is not negative, the method 700 may include processing the feedback and optionally the additional information to learn.

At 720, the method 700 may include selectively updating one or more personas. In some embodiments, the one or more personas may be associated with a user, a device, a location, or any combination thereof. The personas may be updated, for example, by an evolutionary AI engine to reflect user selections. Continuing to 722, the method 700 may include selectively updating search information. In some embodiments, the method 700 may include searching for “better” options based on the feedback and ranking the “better” options using the one or more updated personas. In some embodiments, the method 700 may also include providing feedback to the yield management system, which may provide “better” options.

While the examples provided above with respect to FIGS. 1-7 were primarily directed to travel purchase options, the systems, methods, and devices may also be applied to other types of products. Further, the method of processing feedback to provide competing options may be used with other types of products. In some embodiments, the methods and systems may be applied to some or all parties within an electronic transaction, including end suppliers as well as middlemen. In some embodiments, the system may facilitate suppliers competing against one another for a consumer's business. In some embodiments, the system may also facilitate consumers bidding against one another for a supplier's business. In some embodiments, the system may negotiate on behalf of the consumer or vice versa.

The processes, machines, and manufactures (and improvements thereof) described herein are particularly useful improvements for receiving and utilizing feedback in real time or near real time. Further, the embodiments and examples herein provide improvements in the technology of purchases, enabling a consumer to provide feedback and possibly receive additional options based upon the feedback. In some embodiments, the additional options provided in response to feedback may enhance loyalty to the site from the consumer, reduce turnover and consumer departures, and changes the sales offering situation from one in which the suppliers do not know what is happening in the minds of consumers to one where the suppliers have insight into what is motivating particular consumers.

In addition, embodiments and examples herein provide improvements to the functioning of a system for providing purchase options to a consumer thereby creating a specific purpose computer system by adding such technology. Thus, the improvements herein provide for technical advantages, such as enabling consumer feedback and providing additional purchase options based on the feedback. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A data storage device comprising instructions that, when executed by a processor, cause the processor to:
receive feedback corresponding to a plurality of purchase options from a device via a network;
selectively communicate data related to the feedback to at least one of a supplier and a yield management system;
receive data from at least one of the supplier and the yield management system based on the feedback; and
provide a graphical user interface including the received data to the device via the network, the received data including at least one of a competing purchase option, information related to the feedback, and recommendations.

2. The data storage device of claim 1, further comprising instructions that, when executed, cause the processor to process the feedback to modify at least one of a persona and a search path based on the feedback.

3. The data storage device of claim 1, wherein the plurality of purchase options and the received data comprise travel itineraries.

4. The data storage device of claim 1, further comprising instructions that, when executed, before selectively communicating the data, cause the processor to:
validate the feedback; and
communicate at least one of validation information and reliability information with the data related to the feedback.

5. The data storage device of claim 1, wherein the feedback includes data corresponding to a different purchase option that is exclusive of the plurality of purchase options.

6. The data storage device of claim 1, further comprising instructions that, when executed, cause the processor to:
determine a reliability of the feedback based on one of validating a better option received with the feedback and determine a reliability of a user associated with the feedback based on historical data; and
providing data related to the feedback and the reliability to a yield management system and optionally to the one or more suppliers.

7. The data storage device of claim 6, wherein determining the reliability comprises at least one of:
searching one or more data sources to verify the feedback; and
searching a data source to determine a reliability of a user associated with the feedback.

8. The data storage device of claim 1, further comprising instructions that, before receiving the feedback, cause the processor to:
receive a query from the device;
determine the plurality of purchase options in response to the query; and
provide a graphical user interface including the plurality of purchase options to the device, the graphical user interface including user-selectable elements accessible by a user to provide the feedback related to one or more of the plurality of purchase options.

9. The data storage device of claim 8, wherein the graphical user interface is configured to receive the feedback in one or more formats including text, images, video, and audio formats.

10. The data storage device of claim 1, further comprising instructions that, after receiving the feedback, cause the processor to:
update a persona based on the feedback.

11. A method comprising:
providing purchase options to a device;
receiving feedback from the device including data related to at least one of the purchase options;
determining a reliability associated with the feedback;
communicating data related to the feedback and the reliability to a yield management system and to at least one supplier;
receiving data from the yield management system and the at least one supplier in response to the data related to the feedback; and
selectively providing at least a portion of the received data to the device, the received data including at least one of a competing purchase option to compete with a preferred option communicated in the feedback, advice related to the one of the purchase options and the preferred option, and an explanation about why no competing purchase option is provided.

12. The method of claim 11, further comprising:
querying a yield management system and optionally one or more supplier devices for the competing purchase options;
receiving one or more competing purchase options from at least one of the yield management system and the one or more supplier devices;
compiling the received one or more competing purchase options; and
weighing the received one or more competing purchase options according to at least one persona selected from a plurality of personas.

13. The method of claim 11, further comprising providing the weighed competing purchase options to the device.

14. The method of claim 11, wherein determining the reliability comprises confirming a validity of a different purchase option provided in the feedback by searching one or more data sources for the different purchase option.

15. A memory device comprising instructions that, when executed, cause a process to:
receiving feedback from a device in response to providing a set of purchase options;
determine a reliability of the feedback;
communicate the feedback and the reliability to at least one of a yield management system and a supplier;
receive data from at least one of the yield management system and the supplier, the data related to the feedback; and
provide at least a portion of the received data to the device.

16. The memory device of claim 15, wherein the portion of the received data includes a competing option to compete with a better option provided in the feedback, the competing option to compete with the better option with respect to at least one parameter.

17. The memory device of claim 15, the memory device further comprising instructions that, when executed, cause the process to:
determine a feedback history of a consumer associated with the device;
determine the reliability of the feedback based on at least one of the feedback history and confirmation of the feedback by searching one or more suppliers.

18. The memory device of claim 15, wherein the data received from one of the yield management system and the supplier comprises at least one of a recommendation and an explanation related to a better option identified in the feedback.

19. The memory device of claim 16, further comprising instructions that, when executed, cause the processor to:
search one or more data sources to confirm the existence of the better option;
provide confirmation of the better option to the yield management system and the supplier when the existence is confirmed; and
determine a reliability of the feedback when the better option cannot be confirmed or when a time to confirm of the better option would exceed a threshold.

20. The memory device of claim 19, further comprising instructions that, when executed, cause the processor to:
provide the data in a graphical user interface including at least one user-selectable element accessible to provide the feedback; and
wherein the feedback comprises at least one of text data, image data, and audio data.
